(19) United States
(12) Patent Application Publication
(10) Pub. No.: US 2019/0139374 A1
(43) Pub. Date: May 9, 2019

(54) SYSTEMS AND METHODS FOR PROVIDING OR ENHANCING GAMING PAYOUTS VIA GAMBLING TICKETS

(71) Applicant: KING SHOW GAMES, INC., Minnetonka, MN (US)

(72) Inventors: Bradley BERMAN, Minnetonka, MN (US); Jacob LAMB, Maple Grove, MN (US)

(21) Appl. No.: 16/183,918

(22) Filed: Nov. 8, 2018

Related U.S. Application Data
(60) Provisional application No. 62/583,415, filed on Nov. 8, 2017.

(51) Int. Cl. G07F 17/34; G07F 17/32

(52) U.S. Cl. CPC G07F 17/34; G07F 17/3244; G07F 17/3213

(57) ABSTRACT

Systems, apparatuses and methods for utilizing virtual pull tabs or other gambling tickets to provide or enhance awards in gaming activities. Embodiments include maintaining a listing of available gambling ticket awards and their respective quantities available for awarding. The listing is displayed so the player can know which pull tabs or analogous tickets remain available to receive as an award. When an available gambling ticket is selected, it is awarded for use to the player, and the listing is updated to reflect the change in quantity of awarded gambling tickets. Embodiments involve forcing certain characteristics in gaming activities, such as forcing a symbol combination on a slot game grid, when the gambling ticket awards such a guaranteed gaming outcome.

### FIELD

This disclosure relates generally to games, and more particularly to systems, apparatuses and methods for using gambling tickets to randomly enhance gaming payouts.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is due to the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes systems, apparatuses and methods that facilitate new and interesting gaming experiences, and provide advantages over the prior art.

### SUMMARY

The present disclosure is directed to systems, apparatuses, computer-readable media, and/or methods that are configured to utilize scratch-off cards, pull tabs, and/or other gambling tickets to provide awards or to enhance awards in gaming activities.

In accordance with one embodiment, a slot game apparatus is provided for issuing gaming awards in a slot game or other gaming activity. A display presents symbols in symbol locations forming a symbol array, and a user interface includes a user input(s) to enable players to initiate and participate in slot game events presented via the symbol array. A wager input device is structured to identify and validate player assets, and to permit the player to play the slot game events when the player assets are provided. A processor is configured to populate the symbol array with the symbols, to enable the player to participate in the slot game event. The processor maintains a listing of available gaming ticket awards and their respective quantities available for awarding, and directs the display to present the listing. The processor is configured to select an available gaming ticket award that has not been expended, which in one embodiment is determined by selecting an available gaming ticket award whose associated quantity has not fallen to zero. The processor is further configured to award the selected gaming ticket award, and to update the quantity of the available gaming award tickets for the selected gaming ticket award to reduce its respective quantity available for awarding, as a result of awarding the selected gaming ticket award. The processor is further configured to provide a slot event outcome of the slot game in addition to awarding the selected gaming ticket award. In accordance with a more particular embodiment of such a slot game apparatus, the selected gaming ticket award includes a guaranteed symbol combination, and the processor is configured to force the symbol array to be populated with at least the guaranteed symbol combination.

According to another particular embodiment of the apparatus, the selected gaming ticket award includes a payout modifier, where the processor is configured to increase a payout from the slot event outcome based on the payout modifier.

In yet another embodiment, the selected gaming ticket award includes one or more predetermined symbols of value, where the processor is configured to populate the symbol array with the plurality of symbols and with the one or more predetermined symbols of value.

According to another embodiment of such a slot game apparatus, the processor is configured to reset the quantities of available gaming ticket awards to a reset state, in response to a predetermined quantity of the gaming ticket awards being awarded. In a more particular embodiment, the predetermined quantity of the gaming ticket awards may correspond to all of the gaming ticket awards.

In another embodiment of such an apparatus, the processor is configured to select one of the available gaming ticket awards by randomly selecting among the available gaming ticket awards based on a relative selection weighting.

In still another embodiment of the apparatus, the processor is configured to select one of the available gaming ticket awards on a random basis, while in other embodiments the processor is configured to select one of the available gaming ticket awards in connection with each of the slot game events.

In another embodiment of the slot game apparatus, the display further presents a representation of a pull tab bin, and the processor is configured to select one of the available gaming ticket awards by removing the selected one of the available gaming ticket awards from the pull tab bin.

The processor may be further configured to award the selected gaming ticket award for use with a current slot game event, or for use with a future slot game event.

In accordance with another embodiment, a gaming apparatus utilizing symbols to identify winning results is provided. The gaming apparatus includes a symbol selection module configured to select symbols for a slot game event. The gaming apparatus further includes a display to present the selected symbols in a symbol array of the slot game event, and to present a listing of available pull tab awards and their respective quantities available to be awarded. A pull tab selection module is configured to select one of the pull tab awards available to be awarded. An award availability maintenance module is coupled to the pull tab selection module to receive an identification of the selected one of the pull tab awards, and to update the listing of available pull tab awards by decrementing the quantity of the selected pull tab award as a result of it being selected. An award enhancement module is configured to apply the selected pull tab award to arrive at a total payout for the slot game event.

According to a more particular embodiment of such a gaming apparatus, the selected pull tab award includes a slot game event outcome. In such an embodiment, a forced outcome module may be coupled to the symbol selection module to force the slot game event outcome onto a symbol grid of the slot game event. In a more particular embodiment, the award enhancement module is configured to apply the slot game event outcome to the symbol selection module by way of the forced outcome module, to arrive at a total payout for the slot game event, including a payout for the slot game event outcome forced onto the symbol grid of the slot game event. In another particular embodiment, the slot game event outcome includes a predetermined symbol combination, a progressive jackpot, or a bonus event trigger.

In another particular embodiment of such a gaming apparatus, the selected pull tab award includes a payout modifier, and the award enhancement module is configured to apply the payout modifier to a payout of the slot game event to arrive at the total payout for the slot game event.

In still another variation of the gaming apparatus, the selected pull tab award includes enriched symbol characteristics, and the award enhancement module is coupled to the symbol selection module to cause the symbol selection module to apply the enriched symbol characteristics to the symbols selected for the slot game event.

Another embodiment of the gaming apparatus further includes a pull tab offering determination module configured to randomly select the slot game events in which the pull tab selection module is to select one of the pull tab awards.

In another embodiment, a method for providing gaming awards in a slot game is provided. The method involves populating the symbol array with a plurality of slot game symbols for player participation in a slot game event, maintaining a listing of available gaming ticket awards and their respective quantities available for awarding, and directing the display to present the listing. The method further involves selecting an available gaming ticket award that has a non-zero quantity available for awarding, and that identifies a symbol combination to apply to the next slot game event. The method further involves awarding the selected gaming ticket award, and updating the quantity of the available gaming award tickets for the selected gaming ticket award to reduce its respective quantity available for awarding as a result of awarding the selected gaming ticket award. A slot event outcome of the slot game is provided in addition to awarding the selected gaming ticket award. The next slot game event is forced to be populated with at least the identified symbol combination.

This summary serves as an abbreviated, selective introduction of a representative subset of various concepts and embodiments that are further described or taught to those skilled in the art in the Specification herein. This summary is not intended to refer to all embodiments, scopes, or breadths of claims otherwise supported by the Specification, nor to identify essential features of the claimed subject matter, nor to limit the scope of the claimed subject matter.

### BRIEF DESCRIPTION OF THE DRAWINGS

FIG. 1 is a diagram of a representative gaming machine capable of facilitating player use and interaction with games and features in accordance with the invention and representative embodiments described herein.

FIG. 2 is a block diagram illustrating a representative computing arrangement capable of implementing games and features in accordance with the invention and representative embodiments described herein.

FIG. 3 is an example of a game utilizing pull tabs as a means to provide awards, award modifiers, and/or other gaming benefits.

FIG. 4 illustrates a representative embodiment of an operational arrangement of a gaming device that beneficially provides gaming participants with manners of perceiving available opportunities to provide or enhance gaming payouts.

FIG. 5 depicts a representative embodiment for forcing gaming event results in response to receiving a ticket award for a guaranteed gaming event outcome.

FIG. 6 depicts representative ticket awards and associated categories.

FIGS. 7A, 7B and 7C depict representative examples of providing ticket awards in connection with slot games.

FIG. 8 is a block diagram of a representative gaming apparatus for providing or enhancing awards and/or payouts by awarding pull tabs or other ticket awards.

FIGS. 9A and 9B are described in the context of an electronic poker embodiment, where a ticket award is provided to one or more poker hands.

### DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatuses.

In various embodiments, the gaming displays are described in conjunction with the use of data in the form of “symbols.” In the context of this disclosure, a “symbol” may generally refer at least to a collection of one or more arbitrary indicia or signs that have some conventional or defined significance. In particular, the symbol may represent values that can at least be used to determine whether to award a payout. A symbol may include numbers, letters, shapes, pictures, textures, colors, sounds, etc., and any combination therebetween. A play state, such as a win, can be determined by comparing the symbol with one or more other symbols. Such comparisons can be performed, for example, via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for providing awards in gaming activities, and more particularly for enhancing gaming payouts and/or providing payout modifiers and other payout enhancements via physical or electronic/virtual gambling tickets. Awards, award modifiers/enhancers, enriched symbols or symbol sets, and/or other player benefits having gaming-related value are available to the gaming participant, where at least some of such player benefits may occur in parallel with, or otherwise as an auxiliary gaming event to, other gaming activity (e.g., primary or main game results).

The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. slot game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that involves enhancing gaming payouts and/or providing payout modifiers and other payout enhancements via physical or electronic/virtual gambling tickets. For example, multipliers, bonus triggers, progressive jackpots, guaranteed wins, wild symbol placements, and/or other gaming award-related features may be provided by pull tabs or scratch-off cards to identify the awarded prize.

Numerous variations are possible in view of these and other embodiments of the inventive concept. Representative embodiments and variations are described herein, with some embodiments described with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, roulette, bingo, or other games of chance. Some of these other types of embodiments will be discussed below as variations to the examples illustrated. However, many other types of games can implement similar techniques and fall within the scope of this disclosed concept.

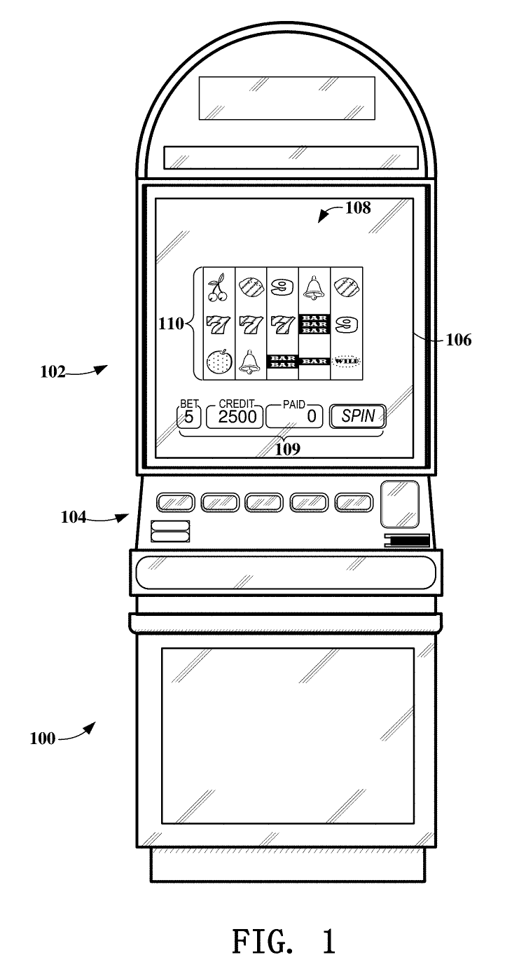

Referring to the example gaming apparatus 100 shown in FIG. 1, the representative gaming apparatus includes at least a display area(s) 102 (also referred to as a gaming display), and a player interface area(s) 104, although some or all of the interactive mechanisms included in the user interface area 104 may be provided via other or additional means, such as graphical icons used with a touch screen in the display area 102 in some embodiments. The display area 102 may include one or more game displays 106 (also referred to as “displays” or “gaming displays”) that may be included in physically separate displays or as portions of a common large display. Here, the representative game display 106 includes at least a primary game play portion 108 that displays game elements and symbols 110, and an operations portion 109 that can include meters, various game buttons and other input mechanisms, and/or other game information for a player of the gaming device 100.

The user interface 104 allows the user to control, engage in play of, and otherwise interact with the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, touchscreen input, tactile input, and/or any other user input system or mechanism that allows the user to play and interact with the particular gaming activity.

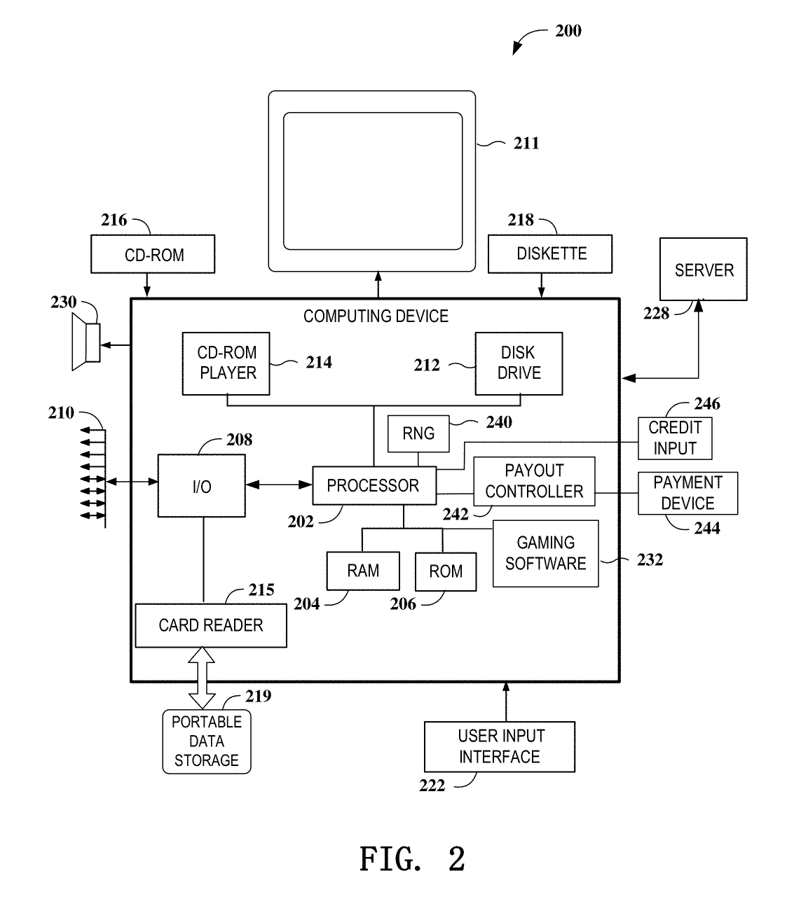

The user interface 104 may allow the user or player to enter coins, bills, or otherwise obtain credits through vouchers, tokens, credit cards, tickets, electronic money, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player information, such as player loyalty information to identify a user or player of the gaming device. This mechanism may be, for example, a card reader, biometric scanner, keypad, or other input device. It is through a user interface such as the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as pay table information associated with a glass/plastic panel(s) on the gaming machine 100 and/or graphical images. The symbols or other indicia associated with the play of the game may be presented on an electronic display device or on mechanical devices associated with a mechanical display. Generally, in some embodiments, the display 106 devotes the largest portion of viewable area to the primary gaming portion 108. The primary gaming portion 108 may provide visual feedback to the user for any selected game. The primary gaming portion 108 may render graphical objects such as cards, slot reels, dice, animated characters, and any other gaming visual known in the art. The primary gaming portion 108 may also inform players of the outcome of any particular event, including whether the event resulted in a win or loss.

In some example embodiments illustrated herein, the primary gaming portion 108 may display a grid (or equivalent arrangement) of game elements 110 or game element positions (also referred to herein as “reel stop positions”). As illustrated in the embodiment shown in FIG. 1, the grid includes three rows and five columns of game elements 110, which may form a game outcome(s) of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual symbols, or user controls over stopping or spinning reels. The game display 106 of the display area102 may include other features that are not shown, such as pay tables, navigation controls, etc.

Although FIG. 1 illustrates a particular implementation of some of the embodiments of this invention in a casino or electronic gaming machine (“EGM”), one or more devices may be programmed to play various embodiments of the invention. The concepts and embodiments described herein may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the principles described herein is illustrated in FIG. 2.

Hardware, firmware, software or any combination thereof may be used to perform the various gaming functions, display presentations and operations described herein. The functional modules used in connection with the disclosure may reside in a gaming machine as described, or may alternatively reside on a stand-alone or networked computer. The representative computing structure 200 of FIG. 2 is an example of a computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions described herein includes a processor, such as depicted by the representative central processing unit (CPU) 202, coupled to memory, such as random access memory (RAM) 204, and some variation of read-only memory (ROM) 206 or other persistent storage. The ROM 206 may also represent other types of storage media to store programs, such as programmable ROM (PROM), erasable PROM (EPROM or any technology capable of storing data). The processor 202 may communicate with other internal and external components through input/output (I/O) circuitry 208 and bussing 210, to communicate control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to one or more displays 211, which represent a manner in which the gaming activities may be presented. The display 211 represents the “presentation” of the game information in accordance with the disclosure, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, inputting data to identify a player for a player loyalty system, etc. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG) or other random generator. The fixed and dynamic symbols generated as part of a gaming activity may be produced using one or more RNGs. RNGs may be implemented using hardware, software operable in connection with the processor 202, or some combination of hardware and software. The principles described herein are operable using any known RNG, and may be integrally programmed as part of the processor 202 operation, or alternatively may be a separate RNG controller 240 that may be associated with the computing arrangement 200 or otherwise accessible such as via a network. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server(s) 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 or other processor(s) indicating a payout is to made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout or payment device 244 may also be provided in gaming machine embodiments, where the payment device 244 serves as the mechanism providing the payout to the player or participant. In some embodiments, the payment device 244 may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency or asset. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, or any other player assets, for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payment device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described herein. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a pay table. The software 232 may include instructions to provide other functionality as known in the art or as described and shown herein.

The systems, apparatuses and methods operable via these and analogous computing and gaming devices can support gaming features as described herein. In one embodiment, scratch-off cards, pull tabs, or other instant lottery items are used as a means to provide gaming awards or award enhancements during game play.

Many embodiments may be described in terms of a slot game, where symbols are matched on paylines to determine payout awards. However, the principles described herein are equally applicable to other games of chance, as described herein and as will be readily apparent to those skilled in the art from the teachings herein.

A first embodiment is described in terms of pull tabs. The game may maintain a pull tab-style barrel or bin that holds payout modifiers, payouts, increased value events, and the like, that are shown to the player. In one embodiment, on each reel spin or other gaming event, a pull tab may randomly be provided from the barrel for use in determining gaming payouts. In other embodiments, the chance is provided on every reel spin, or reel spins during a certain event, etc. In one particular embodiment, the pull tabs in the barrel each have a payout multiplier associated therewith, and one or more pull tabs may be randomly obtained from the barrel for use in modifying payouts from the symbol combinations or other payout events associated with the reel spins.

One embodiment involves providing and maintaining a list of all available awards, award modifiers, award types, or whatever award features are provided in the particular game. In connection with that list, a count can be provided, to keep a running tally of the number of each award, modifier, type, etc. that remains for use in the game. At some time, or in connection with some event(s), the barrel may be replenished, thereby returning the count values to reset values or other desired setpoints. For example, in one embodiment, some awards, modifiers, or other player assets may not be reset or replenished until some other one or more, or all, of the other awards, modifiers, or other player assets have been exhausted from the available pull tabs. In other embodiments, one or more of the awards, modifiers, guaranteed wins, etc. associated with a monitored pull tab item may be replenished as soon as its count has fallen to zero. In still other embodiments, the available count of such items may be replenished in any manner, dependent or not on game play conditions and events, dependent or not on wager amounts or side bets, etc.

In one embodiment, it is assumed that the game has a pull tab-style barrel of payout modifiers and a corresponding summary board on the top glass, auxiliary display, or elsewhere. Items in the barrel could include, with associated counts shown on the board or flare, items such as the following representative examples:

Spin Multipliers

Random Wild Placements

Extra Bonus Overlays

Extra Progressive Symbols

Extra Scatter Symbols

Progressives

(any other desired award, award enhancer, etc.)

In one embodiment, on each reel spin, a random draw is performed, and in some percentage (e.g., 20%) of reel spins a pull tab is pulled for use. The result of that pull tab is applied to the spin result (i.e. any payouts, or whatever payouts are allowed to be modified by the pull tabs), and the board counts are updated. At some threshold of items remaining, the board may be reset. For example, a multi-point criteria such as all progressives must be off the board and less than 50 values remain, or any other criterion/criteria.

The board or flare that is maintained for the player may include each award, modifier, etc. that is available via the pull tabs. A representative example is depicted in Table 1 below.

TABLE 1

| AWARD | COUNT |
|---|---|
| Spin Multiplier 2x | 200 |
| Spin Multiplier 3x | 75 |
| Spin Multiplier 4x | 50 |
| Spin Multiplier 5x | 25 |
| Spin Multiplier 10x | 10 |
| Spin Multiplier 20x | 5 |
| 3 Random Wild Placements | 50 |
| 5 Random Wild Placements | 25 |
| Extra Bonus Overlay | 50 |
| Extra Progressive Symbol | 50 |
| Extra Scatter Symbol | 100 |
| Progressive Level 3 | 3 |
| Progressive Level 2 | 2 |
| Progressive Level 1 | 1 |

In one embodiment, the player is presented with a traditional flare representing a pull tab jar when the game starts. The pull tab jar has a defined set of tickets inside, and the results of those tickets are clearly shown on the flare. When the player achieves a triggering result, they get a pull tab and the award or award modifier contained therein. A game using such a gambling ticket feature may use a forced win concept in view of certain awards, such as guaranteed wins, high value wins, etc. Such a forced win concept may override standard win percentages to ensure the award within a certain range of event plays. As noted above, the game may show a traditional pull tab flare or poster that shows the results of all the tickets contained therein. Table 2 depicts another example of a flare, that may represent its state when full:

TABLE 2

| AWARD | COUNT |
|---|---|
| Mega Progressive | 1 |
| Major Progressive | 2 |
| Mini Progressive | 3 |
| M1 5 pay | 10 |
| M2 5 pay | 10 |
| M3 5 pay | 20 |
| M4 5 pay | 20 |
| Bonus 3 trigger | 20 |
| Bonus 4 trigger | 15 |
| Bonus 5 trigger | 10 |
| Symbol Stacks | 1000 |
| Stack of Wilds | 200 |
| 3x multiplier | 150 |
| 4x multiplier | 100 |
| 5x multiplier | 100 |
| 10x multiplier | 50 |
| Boosted Paytable | 1000 |
| Guaranteed Win | 2500 |

As the player triggers the pull tab feature, for example with overlays, the player receives a pull tab(s) from the jar. When the pull tab is removed, the player is given the award and the flare counts are updated. In other embodiments, the flare is not shown, and items are pulled from the jar with replacement. Another variation involves not applying pulled pull tabs immediately or on the current or next reel spin, but rather at some future point, such as a set or random number of reel spins in the future. Any spin modifier, award, or item of value could be added to the flare.

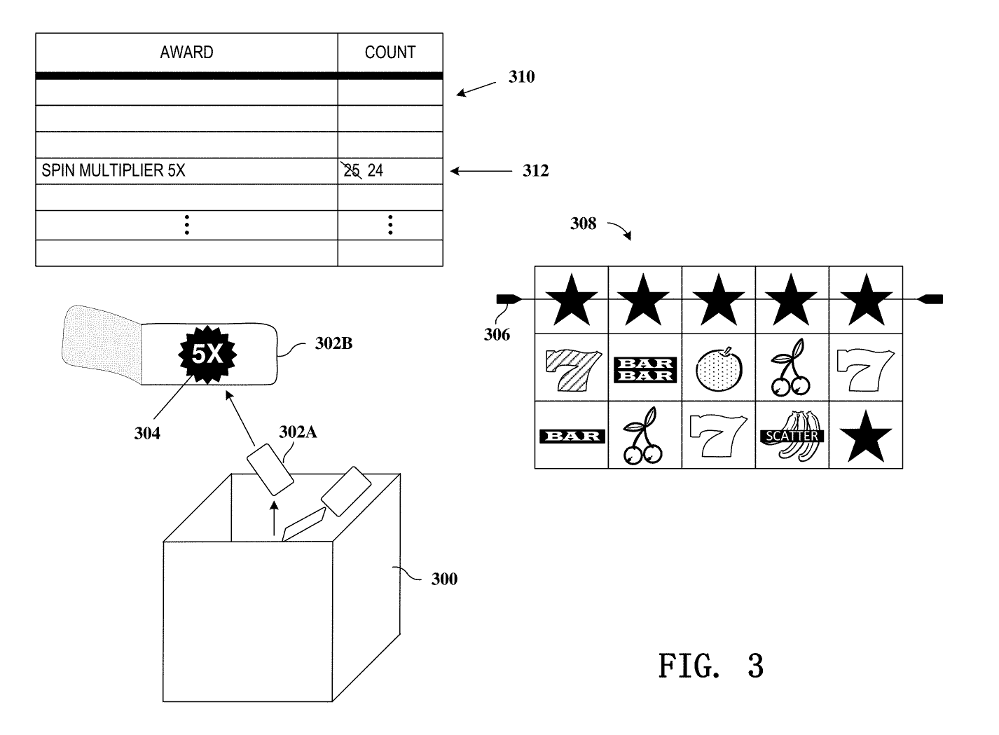

FIG. 3 is an example of a game utilizing pull tabs as a means to provide awards, award modifiers, and/or other gaming benefits. A barrel or jar 300 includes the pull tabs, such as pull tab 302A being pulled from the jar 300. In some instances, physical pull tabs may be used. In other embodiments, the jar 300 is a virtual jar depicted via a display or other presentation mechanism. In the illustrated embodiment, when the pull tab 302A his opened, as depicted by pull tab 302B, an award, award modifier, or other benefit is provided. In the illustrated example, a 5× multiplier 304 is provided, meaning that on the current reel spin, next reel spin, or at some random or designated time, the 5× multiplier 304 can be a applied to a payout. In the illustrated embodiment, the 5× multiplier 304 is applied to a payout occurring on payline 306 of the slot game grid 308. For example, if the five consecutive star symbols on payline 306 results in a 100 credit payout, the total payout would be 500 (100×multiplier of 5). The flare 310, which may be a physical flare or, as in the illustrated embodiment, an electronic flare. The flare 310 is updated to reflect what was obtained from the pull tab 302B, such as depicted by row 312, indicating a 5× spin multiplier was provided, and the number of available 5× multipliers has decreased from 25 to 24. The crossed-out 25 may not be shown to the player, but is depicted here for purposes of example.

Scratch-off cards, display boards, textual lists, and/or any other manner of facilitating revealing awards, modifiers, indicia, etc., could be used instead of pull tabs. In such a case, the scratch-off area would reveal one of the awards, or an update to a count to get an award when the count reaches a predetermined value. Thus, any type of gambling or gaming “ticket” may be used as the vehicle for revealing the benefit granted to the player.

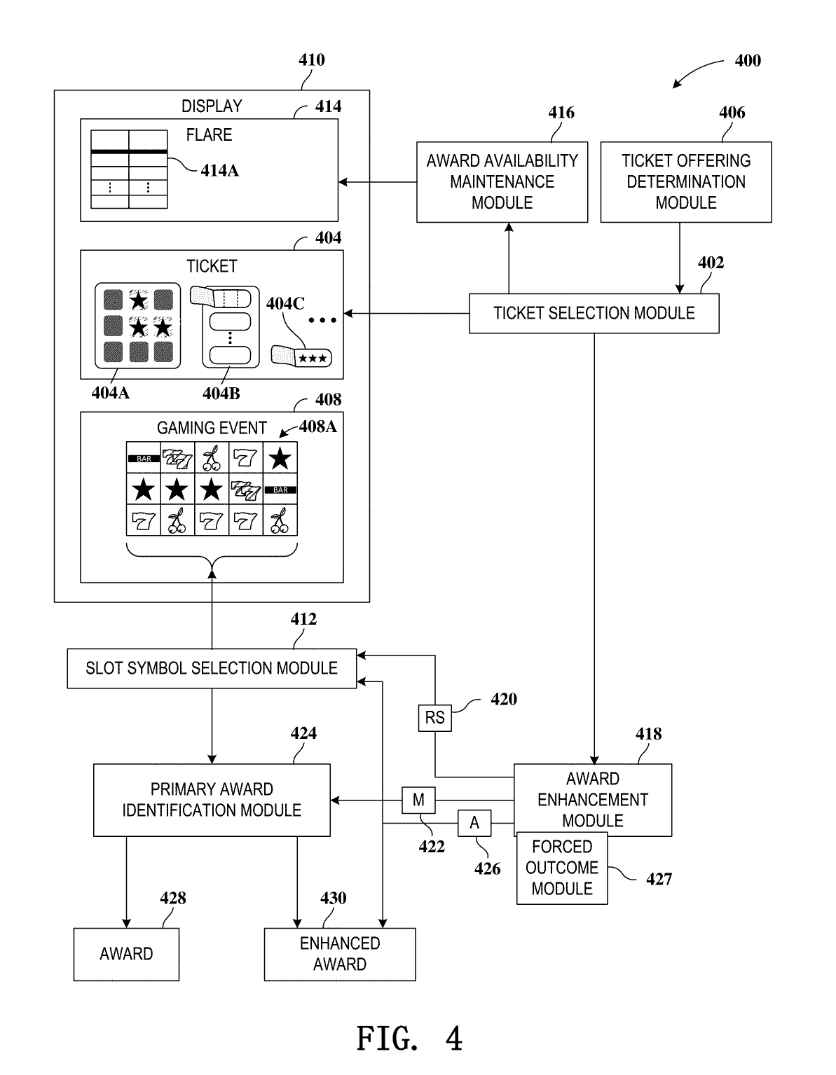

FIG. 4 illustrates a representative embodiment of an operational arrangement of a gaming device that beneficially provides gaming participants with manners of perceiving available opportunities to provide, supplement, or enhance gaming payouts. The representative embodiments of FIG. 4 and other embodiments described herein may be implemented using processing hardware, storage, software, etc. FIG. 4 depicts embodiments where a processing arrangement (e.g., single processors, multiple processors, or any other processing arrangement) is programmed with software and/or firmware to provide various modules to perform functions described herein.

The representative gaming device 400 tracks and exhibits information to players regarding available awards of payout enhancements or grants of other play-related assets, that in some embodiments is provided as a parallel award feature to another gaming event, such as a slot game reel spin. In the illustrated embodiment of FIG. 4, available awards, award modifiers, reel enrichments and other odds or payout enhancers may be made available via a secondary award path relative to another gaming event, and tracked over the course of the game play

For purposes of this example, a “ticket” will the assumed to correspond to any physical item or virtual/electronic presentation capable of identifying direct awards, award modifiers, reel enrichments and other odds or payout enhancers (hereinafter, among other things, “ticket awards”). Such tickets may be provided or presented as, for example, physical or virtual scratch cards, pull tabs, display boards, text and/or audio symbol indications, and/or any other manner of presenting information during gaming events. As such ticket awards are provided, they are tracked to inform the player how many of that ticket award type remain.

A ticket selection module 402 is provided that determines what ticket award (if any) is to be associated with a next ticket 404 provided to the player. The ticket selection module 402 may select from multiple available ticket awards, which may be weighted in some fashion to guide the probabilities of selection of the various ticket awards. The ticket selection module 402 thus corresponds to the hardware, firmware and/or software involved in determining what ticket award will be provided with the issued ticket 404.

In one embodiment, a ticket 404 is provided routinely during participation in another gaming event 408, such as the slot game event 408A. For example, a ticket 404 may be provided in connection with each gaming event 408, such as each reel spin of a slot game event 408A.

In other embodiments, tickets 404 are not provided so routinely, and the ticket offering determination module 406 may determine when the next ticket is to be issued for use in the gaming activity. The ticket offering determination module 406 corresponds to the hardware, firmware and/or software involved in determining when a ticket 404 should be issued, and generating requests to the ticket selection module 402 to do so. It should be recognized that the ticket offering determination module 406 and ticket selection module 402 may be implemented in common hardware, but with different functional modularity as a result of features structured and/or programmed to perform the desired functions.

In one embodiment, issuance of a ticket 404 may be scheduled, such as every Nth reel spin, or on some pattern of reel spins. The ticket offering determination module 406 may track and monitor such a schedule, to cause the ticket selection module 402 to select the content of a ticket 404 when the ticket offering determination module 406 has determined it is time to issue another ticket 404. For example, game rules may indicate that a ticket 404 is to be issued every 5^{th} reel spin, in which case the ticket offering determination module 406 notifies the ticket selection module 402 to provide a ticket 404 every 5^{th} reel spin.

In another embodiment, the ticket offering determination module 406 includes a random event module (not shown) configured to randomly determine when to authorize issuance of the next ticket 404. For example, on each reel spin, a random draw (or any random event) may be performed, where such random draw is based on an even probability distribution, or a weighted distribution, or otherwise configured to provide tickets 404 and ticket results in a manner to stay within the odds and payout parameters desired.

The issued ticket may be displayed in any manner, via a display(s) 410. In one embodiment, the ticket 404 is displayed independently of any other gaming activity or event being displayed, such as in a separate display area from the slot game reel spin 408A or other gaming event 408. In another embodiment, the ticket 404 may be presented in connection with the gaming event 408, such as via an overlay symbol on the slot game 408A grid, sub-symbol associated with a symbol(s) on the slot game 408A grid, positioned as a slot game symbol in a symbol location of the slot game 408A grid, etc. The ticket 404 may be provided in any desired manner, such as a scratch-off card 404A, multi-item pull tab 404B, single-item pull tab 404C, text item, and/or other manner of relaying the content of a selected ticket 404.

The display 410 may also present a gaming event 408, such as a primary gaming event, which is a slot game 408A in the current example, where the slot symbol selection module 412 selects symbols for presentation via the slot game 408A array. In connection with participation in the slot game 408A, the ticket selection module 402 identifies one (in one embodiment) of the awards and/or award-based indicia on the ticket 404 to present. In the case of multi-item tickets (e.g., 404A, 404B), where multiple selectable items may be selected until the ticket award is identified, such selections may be automatically made by the gaming system, or may be made by the player.

In one embodiment, the display 410 also presents a “flare” 414, referring to a poster, board, textual listing, and/or other identification detailing which ticket awards are available, and how many such ticket awards remain available. When a ticket award is made available and used for the benefit of the player, a count of that particular ticket award will be modified to reflect one less (or less however many were used). In one embodiment, when a particular ticket award is no longer available, only other available ticket items identified on the flare 414 may be awarded, until some flare resetting event that resets all, or individual ones, of the available ticket awards. In the illustrated embodiment, the flare table 414A is configured to list each of the available ticket awards, and a corresponding count of how many more of the respective ticket awards can are available for awarding.

In response to the ticket selection module 402 making a selection of a ticket award, the flare 414 is updated in one embodiment. The award availability maintenance module 416 is coupled to the ticket selection module 402 to provide this function. Maintaining a current flare 414 provides, in one embodiment, real-time feedback to the player regarding which ticket awards are available and in what respective quantities. For example, if there are no further top-level progressive ticket awards identified on the flare 414, the player would know that on the next received ticket award (and however many ticket awards received after that until the top-level progressive ticket awards are reset to provide at least one possibility of winning that ticket award), the top-level progressive ticket award will not be won, at least by way of a ticket award.

In response to the ticket selection module 402 identifying a ticket award to provide, the award enhancement module 418 can provide the corresponding award. As noted elsewhere herein, the ticket award provided as a result of awarding of the ticket 404 may be of various types. In one embodiment, the symbol(s) or other indicia identifying a ticket award, or direct notification of the ticket award, may specify an upgrade or enrichment to a current or future gaming event 408. For example, rich symbols (RS) 420 may be awarded for the current slot game 408A spin, and/or one or more subsequent slot game 408A spins, such as an increased quantity of high value symbols, a higher proportion of high value symbols, conversions of lower value symbols into higher value symbols, stacks of symbols, increased paytable payouts for one or more slot game 408A spins, reduced criteria to reach certain results (e.g., reducing the number of matching symbols needed to get a bonus event), or the like. Such rich symbols 420 and other criteria plays into the gaming event 408, such as the slot game 408A, and therefore may impact the current slot game 408A or one or more subsequent slot games 408A.

The award enhancement module 418 may instead or additionally provide award modifiers, such as payout modifiers (M) 422. Payout modifiers 422 may increase or otherwise enhance payouts occurring in connection with another portion of the gaming activity, such as payouts provided in connection with the slot game 408A. One example of such a modifier 422 is a multiplier, which can be multiplied by a payout occurring in the slot game 408A. Thus, where the primary award identification module 424 determines from (for example) the slot symbol selection module 412 that a payout(s) occurred during play of the slot game 408A, that payout(s) may be increased by the modifier (M) 422 identified as a result of the ticket 404 exhibiting information that results in a payout modifier (e.g., a symbol combination identifying a corresponding multiplier, or a direct notification of a multiplier such as a “5×” notification, etc.).

In another embodiment, the ticket award facilitated by the award enhancement module 418 may be a direct award 426 that can be awarded on the current gaming event 408 or a subsequent gaming event 408. For example, a progressive jackpot may be won as a result of the ticket selection module 402. Other guaranteed wins may be provided, such as a high value symbol combination (e.g., a five-symbol combination on a payline of a high value symbol). Another example of a guaranteed win may be a bonus event, free games, etc. Such forced or guaranteed wins may be accomplished in any desired manner suitable, while maintaining the mathematical payout probabilities at a desired point or within a desired range. The award enhancement module 418 may incorporate, or be coupled to a forced outcome module 427 to provide such identified, guaranteed wins. An example of such a forced win concept that may be used in connection with providing such awards (A) 426 is described below.

In cases where the award enhancement module 418 has not provided any award 420, 422, 426, then any award 428 identified by the primary award identification module 424 from activity occurring in connection with the slot game 408A may be provided, as part of the standard/primary gaming event 408. However, the award 428 may in fact be enhanced in some respects, in the event that rich symbols 420 or other gaming event-based benefits are afforded to the slot game 408A, thereby making the award 428 more likely, and/or a higher payout, etc.

When a modifier 422 is provided and applied to a payout identified via the primary award identification module 424, an enhanced award 430 results. If an award 426 is provided, if it is a direct credit value or other direct benefit, it may be added or otherwise associated with the outcome of the primary award identification module 424 to provide an enhanced award 430. In other embodiments, where the award 426 represents a guaranteed win (e.g., a progressive jackpot, a winning symbol combination, a bonus event, a free games event, etc.), then it may direct the slot symbol selection module 412 to cause an outcome.

As noted above, some awards are provided in the form of a guaranteed outcome, such as a guaranteed win of a particular symbol combination, progressive jackpot, bonus event, free spin event, etc. Forcing results or otherwise causing particular results to occur may be accomplished as set forth herein, and/or as described in co-pending U.S. patent application Ser. No. 16/031,289, filed on Jul. 10, 2018, and entitled “Systems and Methods for Overriding Gaming Results,” the content of which is incorporated herein by reference in its entirety. Other manners of causing results to occur in slot games, poker games, and other gaming activities may also be used in connection with the teachings described herein as will be readily apparent to those skilled in the art from the teachings provided herein.

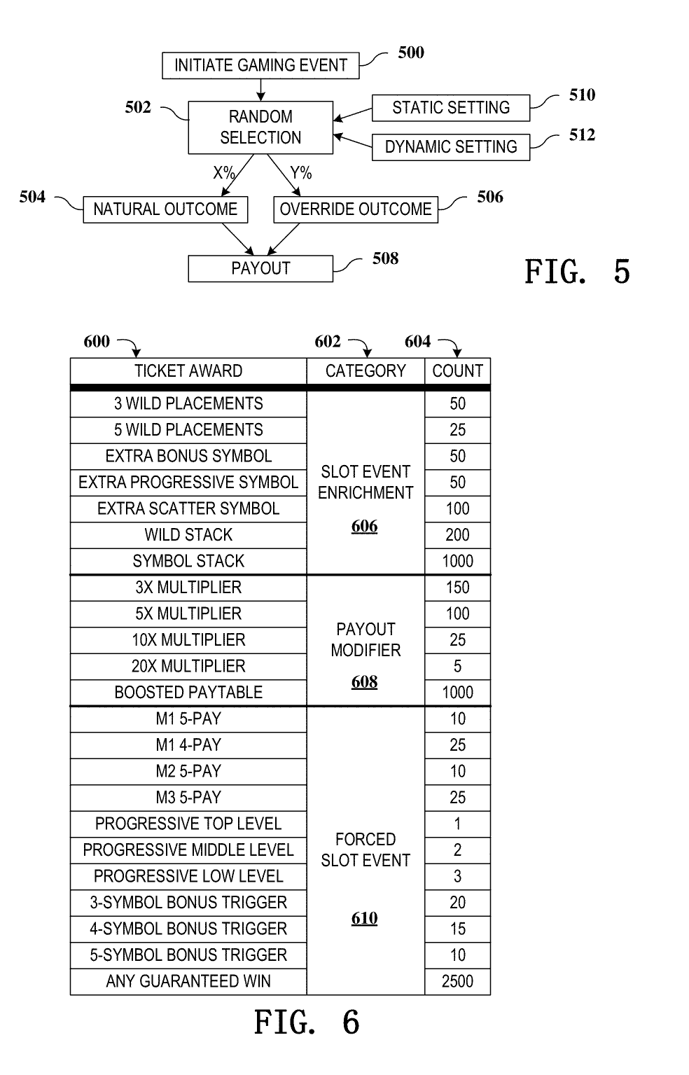

For example, one manner of overriding gaming results is depicted in FIG. 5, where a random selection is made to either enable the natural outcome of a gaming event to occur, or to select from a table, bank or other repository of gaming event outcomes at a desired frequency. The “frequency” of selection from the table, bank, etc. may be temporarily set to ensure that an override outcome will occur.

In the embodiment of FIG. 5, a gaming event is initiated 500, such as physically or virtually spinning slot reels, dealing a poker hand(s), spinning a roulette wheel, identifying selected keno numbers, or any other start of a gaming event. A random selection 502 takes place to randomly determine whether the gaming event natural outcome 504 is allowed to occur, or whether an override outcome 506 will be used instead of the natural outcome 504 of the gaming event. For example, the random selection 502 may be configured to enable the natural outcome 504 to occur X% of the time, and to enable a predefined override outcome 506 to occur Y% of the time.

In one embodiment, there may be just one override outcome 506, such that the random selection 502 selecting the override outcome 506 Y% of the time will cause the single override outcome 506 to be the gaming event outcome Y% of the time. In other embodiments, the override outcome 506 represents a plurality of selectable, predefined gaming event outcomes. Therefore, when the random selection 502 determines that the override outcome 506 will occur Y% of the time, one of the plurality of selectable, predefined gaming event outcomes associated with the override outcomes 506 will be selected. For example, the override outcomes 506 may include a plurality of top awards, and/or other combinations such as a top award and a modifier (e.g., multiplier), etc. in this manner, the natural outcome 504 can be overridden by the random selection 502 and outcome selection within the override outcomes 506. In either case, a payout 508 may be provided in the event that the natural outcome 504 resulted in a winning outcome, or in the event that the selected (or sole if only one) outcome associated with the override outcome 506 has a payout 508 associated therewith.

The weight associated with the random selection 502 is, in one embodiment, adjustable. A static setting 510 may be provided to set the random selection 502 at a particular weighting of natural outcomes 504 and override outcomes 506. In other words, the static setting 510 may enable the random selection 502 to set the percentages, X% and Y%, in which the natural outcome 504 and override outcome 506 will be selected. As an example, the static setting 510 may be set to cause the random selection 502 to cause the natural outcome 504 to be selected 99.9% of the time, while causing the override outcome 506 to occur 0.1% of the time. Where there are multiple predefined gaming event outcomes associated with the override outcomes 506, at least one of those predefined gaming event outcomes will be selected when the random selection 502 allows the override outcome 506 to be utilized. In one embodiment the allocation between natural outcomes and predefined outcomes is set, yet the setting may be adjusted to “re-set” the fixed allocation.

The weight associated with the random selection 502 is, in another embodiment, dynamically adjustable during play of the game. A dynamic setting 512 may be provided to set the random selection 502 at a first weighting of natural outcomes 504 and override outcomes 506, which can change throughout play of multiple gaming events. In other words, the dynamic setting 512 may enable the random selection 502 to adjust and readjust the percentages X% and Y% during play, such as when the award enhancement module 418 of FIG. 4 calls for a guaranteed win on the current or a subsequent slot game 408A as a result of the ticket 404 indicating such a guaranteed win.

As an example, the dynamic setting 512 may temporarily be set (e.g., for one reel spin) in response to a guaranteed win request, to cause the random selection 502 to cause the natural outcome 504 to not be selected, and the override outcome 506 to occur 100% of the time, for that particular spin or other gaming event. When the ticket selection module 402 of FIG. 4 selects a ticket award that identifies a guaranteed result of a reel spin, the dynamic setting 512 can cause the weighting between the X% and Y% to be readjusted, such as causing the override outcome 506 to occur on the next random selection 502.

Thus, in one embodiment, the award enhancement module 418 may facilitate providing a guaranteed result or award 426, which uses a random selection module 502 or analogous module to force that guaranteed result or award 426. The award enhancement module 418 therefore may invoke a forced win function, such as that depicted in FIG. 5. In one embodiment, the award enhancement module 418 identifies the guaranteed award 426, and causes the dynamic setting 512 to set the override outcome 506 to ensure that guaranteed award 426 occurs before the end of the current reel spin event or for the next (or later) reel spin, depending on the desired rules of the game.

As noted above, forcing results may be accomplished as set forth herein, and/or as described in co-pending U.S. patent application Ser. No. 16/031,289, filed on Jul. 10, 2018, entitled “Systems and Methods for Overriding Gaming Results,” the content of which is incorporated herein by reference in its entirety, and/or based on other manners of forcing or guaranteeing a result when indicated or otherwise desired.

Forcing results in such manners enables guaranteed results to be provided in connection with the pull tabs and other ticket awards described herein. Payout modifiers and reel enrichment may, in some embodiments, be applied to current (or future) results, where the reels are changed and/or payouts are increased, but guaranteed wins/results may require an ability to set a particular result(s) at a particular time. Additionally, ticket awards having small or mid-sized awards may also be forced in connection with the scratch card concept to allow the win probabilities and corresponding payouts to remain at a desired level or within a desired range. Thus, a forced result methodology as set forth herein, or other forced result methodologies similarly enabling results to be caused in the desired manner and at the desired time, enable such ticket awards to be used as such forced results can cause particular reel spin results or other gaming results when awarded.

As noted herein, ticket awards may fall into different award categories. FIG. 6 depicts representative ticket awards and associated categories, and is intended to facilitate an understanding of the types of different ticket awards that may be utilized, and is not intended to be a particular list or an exhaustive list of all ticket awards or categories.

One type or category 602 of ticket award 600 is a slot event enrichment category 606, that may include benefits to reels and/or symbols for the primary slot game event (and/or a secondary gaming event in other embodiments). A slot event enrichment category 606 may include, for example, some number of wild symbol placements (e.g., wild symbol overlays) on the slot game grid, extra bonus symbol(s) on reels, extra progressive jackpot symbol(s) on reels, extra scatter pay symbol(s) on the reels, stacks of potentially valuable symbols such as a wild stack or symbol stack of high value symbols, etc.

A payout modifier category 608 may include awards that cause an otherwise awarded payout to be increased, or the manner of determining payouts loosened, or paytables temporarily increased for slot game payouts, etc. A payout modifier category 608 may include, for example, payout multipliers (e.g., 3×, 5×, 10× multipliers), and a boosted paytable that adjusts the slot game paytable for one or more reel spins.

Another category includes the forced slot event category 610. This category includes awards that are to occur in connection with the slot game being played (or other designated gaming event). For example, if a ticket was obtained that indicated a win of 1000 credits, that amount could just be awarded without any need to manipulate symbols of the primary slot game event. However, if a ticket was obtained that indicated an “award” of five consecutive top-level symbols on a payline, this means that the player will, on the current or a subsequent reel spin, get that symbol combination on the played slot game event and win the corresponding payout. To allow this to happen, such symbol combinations or other analogous awards may be forced onto the slot game grid to cause that result to actually occur.

Representative ticket awards 600 in a representative forced slot event category 602 may include, for example, high value winning symbol combinations. For example, the player could receive a ticket award 600 involving a top-level major symbol (referred to as an M1 symbol in this example), such as an M1 5-pay (i.e. five consecutive M1 symbols on a payline, or scatter pay, etc.), or an M1 4-pay, or M2 5-pay (i.e. five consecutive second-level major symbols), or M3 5-pay, etc. If any such ticket awards 600 are identified on an awarded pull tab or other ticket, the player will receive such award on the current play (e.g., if the reels are still spinning), or on the next reel spin, or on some other future spin possibly made known to the player specifically or in some range.

Another example of ticket awards 600 in the forced slot event category 610 include jackpot awards, such as a top level progressive jackpot, mid-level progressive jackpot, low level progressive jackpot, etc. Similarly, bonus events may be triggered with a symbol(s), or symbol combination, etc., and various bonus trigger ticket awards 600 may be provided. For example, a bonus event may be triggered with 3 bonus symbols provided anywhere on the slot grid, which enters the bonus event at a stage commensurate with obtaining 3 bonus symbols; a bonus event may be triggered with 4 bonus symbols provided anywhere on the slot grid, which enters the bonus event at a stage commensurate with obtaining 4 bonus symbols; etc.

Another example of a ticket award 600 in the forced slot event category 610 is any guaranteed win. For example, a ticket award 600 may be obtained by the player that indicates that a guaranteed win will occur on the next reel spin, but the particular winning result may not be relayed to the player. Therefore, the guaranteed win could be a high value win with a high payout, or a low value win with a low payout. In any event, some win will be guaranteed. In one embodiment, the system can determine if a win will already occur on the slot event in which a win is guaranteed, and no further win is therefore provided. In another embodiment, the system can determine if a win will already occur on the slot event in which a win is guaranteed, and provide an additional, randomly-determined win anyway by forcing the additional winning result. In another embodiment, where the system determines there would be no win without forcing a win, in which case a random winning event may be selected, and forced to occur. These and other manners of providing guaranteed wins may be utilized, where forced results with resulting payouts may be implemented to effect such forced slot events 610.

Each of the various ticket awards 600 are provided in numbers identified by the representative, example count 604. Therefore, if a ticket award of 3 wild placements was provided, the respective count 604 would decrement by one (assuming a decrementing count). In one embodiment, when the count reaches zero where there are no further ticket awards available for that item, the count may not (in some embodiments) be reset until some other event occurs, such as all ticket awards 600 being depleted to zero, or at least to some collective threshold amount (e.g., total count 10% of starting/reset count), or the like. In other embodiments, the count may be reset when a category 602 has been fully exhausted rather than all ticket awards 600 being fully exhausted, or when a category 602 reaches some threshold amount. In other embodiments, individual ones of the ticket awards 600 may be reset once fully exhausted, or based on other criteria. Where some of the ticket awards 600 have respective count 604 values of zero, those ticket awards will no longer be selected until a reset occurs, which in one embodiment raises the likelihood of selecting other ones of the ticket awards 600 that still have a non-zero count 604.

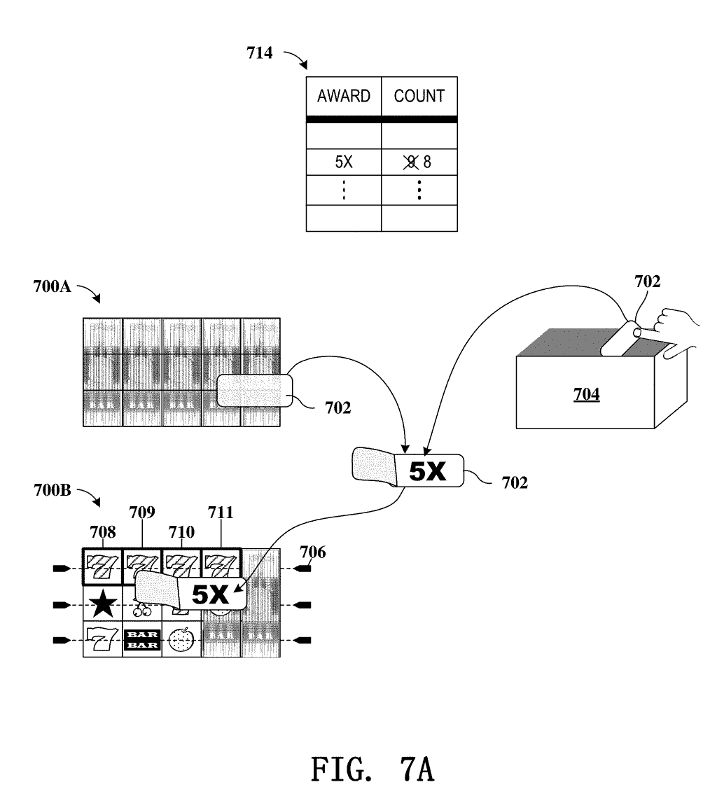

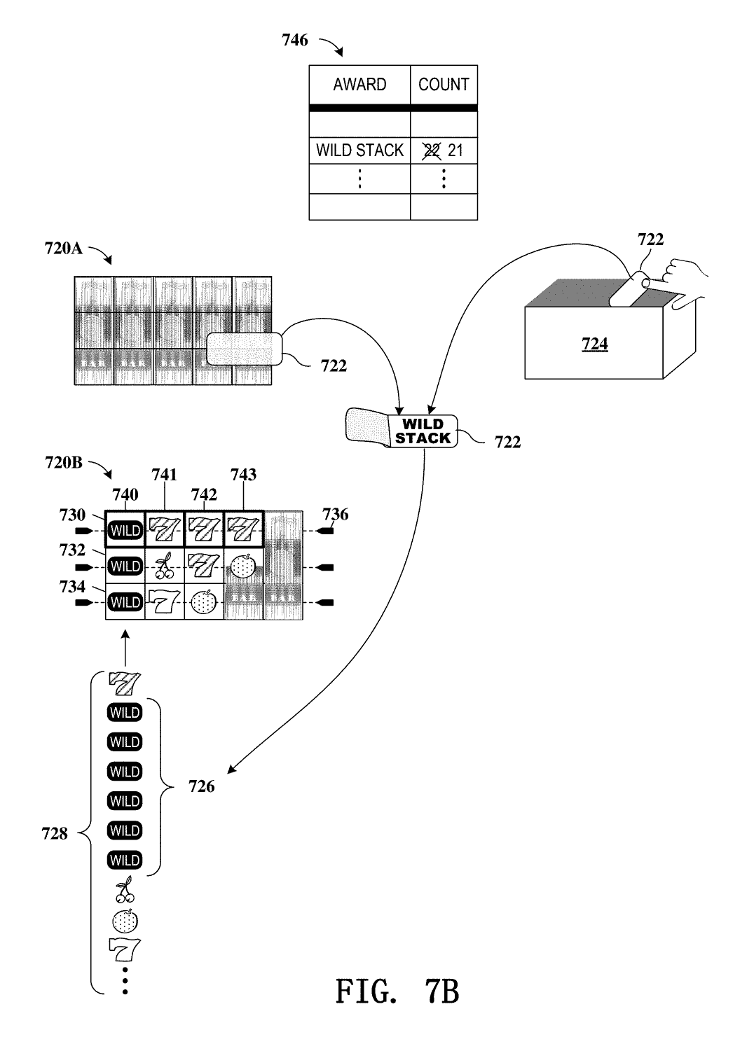

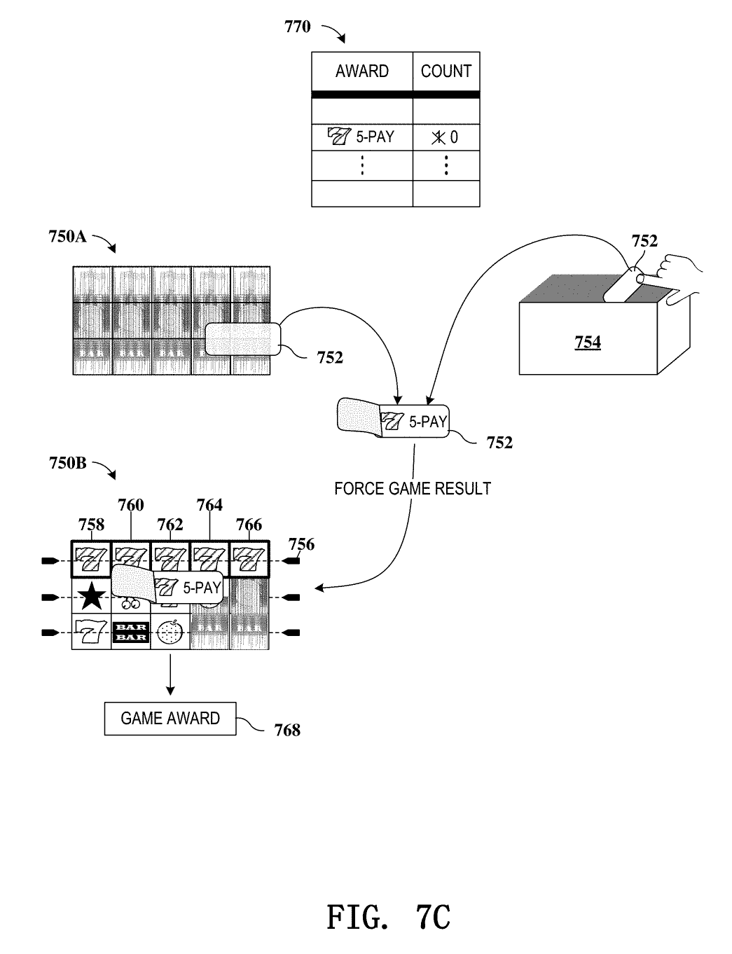

FIGS. 7A, 7B and 7C depict representative examples of providing ticket awards in connection with slot games. The example of FIG. 7A depicts a slot game grid 700A in which a slot game event (e.g., reel spin) is taking place. In one embodiment, ticket awards may be provided occasionally, such as in response to a random event. For example, a random selection may be established where a weighting is 20% chance that a ticket award will be provided in connection with a slot game event. In other embodiments, a ticket award may be provided systematically, such as in connection with every slot game event. In one embodiment, a granted ticket award 702 may be presented in any manner on a display, such as presented as an overlay to the slot game grid 700A, in a separate display area, etc. In another embodiment, the granted ticket award 702 may be visually shown as being pulled from a pull tab jar or bin 704, or the player may be allowed to select a pull tab from the bin 704. In the illustrated example, the granted ticket award 702 is a payout modifier, and more particularly a 5× multiplier to be applied to one, more, or all of the payouts occurring in connection with the slot game event. The slot game grid 700B represents the state of the slot game grid 700A after the slot game reels have stopped spinning, or the symbols have otherwise been populated thereon. In this example, a four-symbol combination has occurred on payline 706, namely symbols 708, 709, 710 and 711 on payline 706. Assuming this 4-pay of “seven” symbols is defined to provide a payout, that payout would be multiplied by the awarded 5× multiplier, to provide an enhanced payout as a result of the granted ticket award 702. The displayed flare 714 would be updated to reflect one less count of 5× multipliers as a result of the granted ticket award 702, thereby providing real-time feedback to the player as to how many 5× multipliers can still be awarded.

The example of FIG. 7B depicts a slot game grid 720A in which a slot game event is taking place. In one embodiment, a granted ticket award 722 may be displayed in any manner, such as in connection with the slot game grid 720A, being pulled from a pull tab bin 724 by the system or the player, in a separate display portion, etc. In the illustrated example, the granted ticket award 722 is a slot event enrichment award, which is a stack of wild symbols in this example. The stack of wild symbols may be any number of consecutive wild symbols that is added to or replaced on one or more reels or symbol locations of the slot grid 720B, and may populate the entire reel(s) with the wild symbols, or any portion thereof. In the illustrated embodiment, the granted ticket award 722 results in some number of consecutive wild symbols 726 added to the reel strip 728 for the first column of the slot game grid 720B, which represents the state of the slot game grid 700A after the slot game reels have stopped spinning, or the symbols have otherwise been populated thereon. In this example, the enriched reel 728 resulting from the ticket award 722 enabled wild symbols to be populated at symbol locations 730, 732 and 734. As a result, a four-symbol combination has occurred on payline 736, namely symbols 740, 741, 742 and 743 on payline 736, where symbol 740 is one of the wild symbols obtained as part of the wild symbols 726 added to the reel strip 728. While in some embodiments reel or symbol enrichment in these manners does not guarantee a winning slot game event or accompanying payout, it may enhance the conditions of the slot game event to increase the chances of winning (as is the case in the example of FIG. 7B), and/or increase the chances of a higher resulting payout, etc. The displayed flare 746 would be updated to reflect one less count of wild stacks as a result of the granted ticket award 722, thereby providing real-time feedback to the player as to how many wild stacks can still be awarded.

The example of FIG. 7C depicts a slot game grid 750A in which a slot game event is taking place. In one embodiment, a granted ticket award 752 may be displayed in any manner, such as in connection with the slot game grid 750A, being pulled from a pull tab bin 754 by the system or the player, in a separate display portion, etc. In the illustrated example, the granted ticket award 752 is a particular symbol combination, namely, a “7” 5-pay (i.e. five “7” symbols in an arrangement resulting in a payout). Using a forced win feature as described herein (or otherwise available to cause a particular symbol combination or arrangement to be populated onto the current or next slot game grid 750B), that awarded ticket award 752 is populated onto the slot game grid 750B. In the illustrated embodiment, the ticket award 752 is populated onto payline 756 at symbol locations 758, 760, 762, 764, and 766. The game award 768 that corresponds to the forced result identified via the ticket award 752 is then awarded to the player. The displayed flare 770 would be updated to reflect one less count of the 5-pay of “7” symbols. In the illustrated embodiment, the count goes from 1 to 0, meaning that no further “7” 5-pays will be awarded, until the bin 754 is reset, or at least the count for “7” 5-pays is reset.

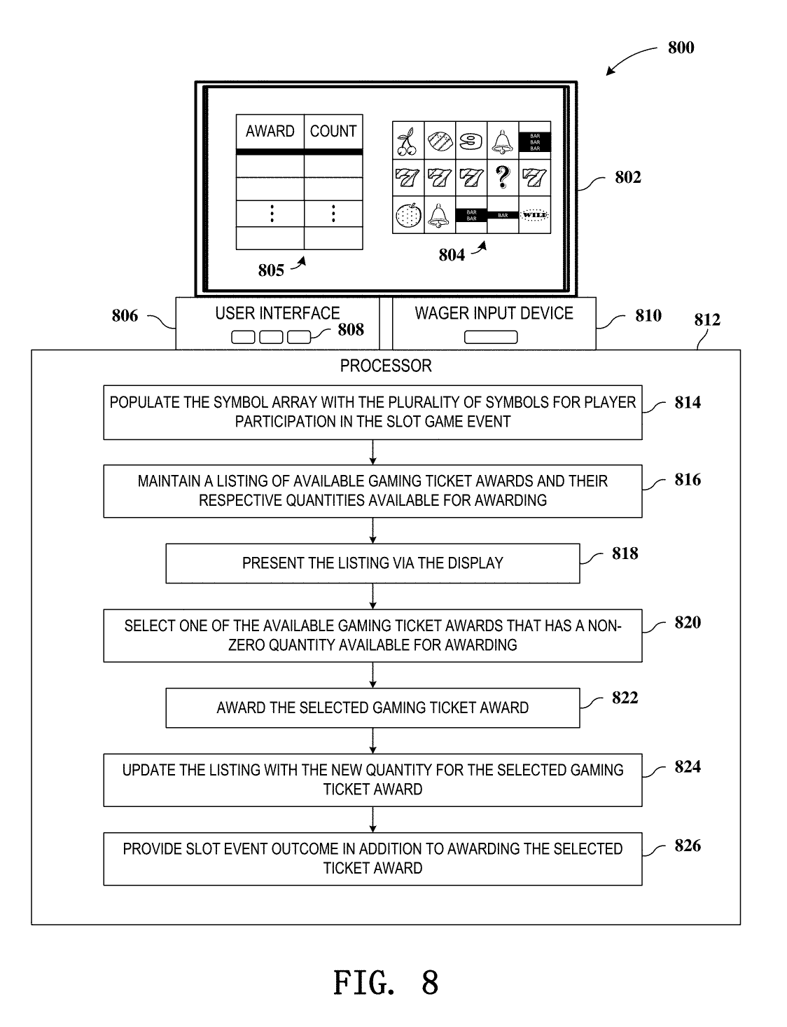

FIG. 8 is a block diagram of a representative gaming apparatus for providing or enhancing awards and/or payouts by awarding pull tabs or other ticket awards. In the embodiment of FIG. 8, a symbol-based gaming apparatus (e.g., slot game device) 800 is provided on which players can play slot games. Other games may instead be used as a primary game, such as poker, or other games involving symbols or indicia in the determination of winning results. The representative slot game device 800 includes at least a display(s) 802 presenting a slot game symbol array or “grid” 804 of symbols, as well as presenting a listing 805 of available ticket awards and their respective quantities available for awarding. A user interface 806 is provided that includes at least one user input 808 to enable a player to initiate and participate in slot game events presented via the slot game grid 804, and a wager input device 810 structured to identify and validate player assets and ultimately permit the player to play the slot game event when the player assets are provided.

A processor 812 is configured to populate 814 the symbol array with symbols, thereby enabling a player to participate in the slot game event. The processor maintains 816 a listing of available ticket awards and their respective quantities available for awarding, and directs the display to present 818 that maintained listing. One (or more) of the available ticket awards is selected 820, if it has a non-zero quantity available for awarding. Those ticket awards having a zero quantity associated therewith have exhausted themselves from the pull tab bin or other ticket award pool, at least until the ticket award pool or that ticket award is reset to a non-zero count. The processor is further configured to award 822 the selected ticket award, and to update 824 the quantity of the available award tickets for the selected ticket award to reduce its respective quantity available for awarding as a result of awarding the selected ticket award. In one embodiment, the processor is further configured to provide 826 a slot event outcome of the slot game in addition to awarding the selected ticket award.

In one embodiment, the awarding 822 of the gaming ticket awards serves as a primary game. In such an embodiment, the symbol array 804, populating 814 the symbol array, and providing 826 a slot event outcome are not involved. In still other embodiments, the gaming event, is not a slot game event, but rather is some other gambling methodology, such as video poker, keno, roulette, bingo, or the like.

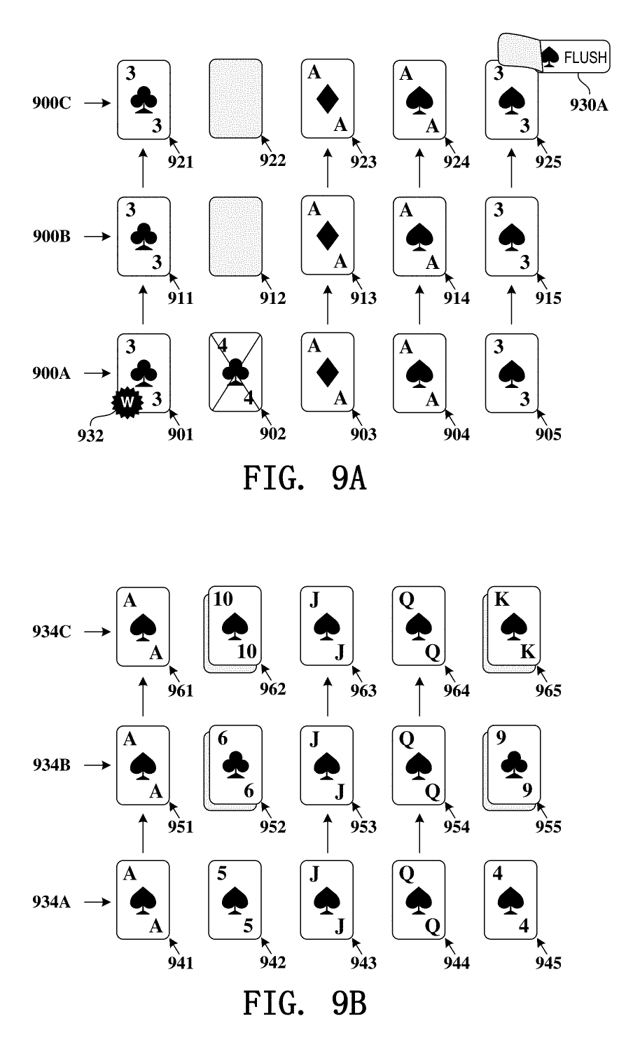

Accordingly, the principles described herein are equally applicable to other gaming events, whether associated with a primary gaming event(s) or a secondary gaming event(s). FIGS. 9A and 9B are described in the context of an electronic poker embodiment, where a ticket award is provided to one or more poker hands. The poker embodiment may involve a single hand, or may be a multi-play embodiment where one or more additional hands are played, where there is involvement between the multiple hands or whether each of the multiple hands is played independently. The representative embodiment of FIGS. 9A depicts an electronic, multi-play, poker game embodiment involving three concurrently-played hands 900A, 900B and 900C associated with a first gaming event (poker deal), although as few as one hand 900A could be played, and as many more than three hands as desired.

FIG. 9A in this example represents a first poker event being played, that includes a first, original hand 900A, and one or more additional hands 900B, 900C. The first hand 900A is dealt, including, in this example, cards 3-Clubs, 4-Clubs, Ace-Diamonds, Ace-Spades, and 3-Spades at card positions 901, 902, 903, 904 and 905 respectively. Hand 900B includes card positions 911-915, and hand 900C includes card positions 921-925. In accordance with one embodiment of multi-play draw poker, in which the present example assumes, cards held in one hand 900A are replicated into the other hands 900B, 900C.

In connection with the played poker hands, whether a single hand 900A or multiple hands 900A, 900B, 900C, a pull tab 930 or other analogous ticket may be presented. The pull tab 930 may be presented randomly, or may be presented on each new poker hand played, or may be presented if some other indicator occurs such as a sub-symbol(s) 932 on one or more cards, etc. In the illustrated embodiment of FIG. 9A, the pull tab 930 is assumed to be awarded for a subsequent (e.g., the next) hand, although it could be applied to one, more, or all of the hands 900A, 900B, 900C instead of or in addition to being applied to a subsequent hand. In this example, it is assumed that the pull tab 930 has granted an award of a flush of spades.

On the following hand depicted in FIG. 9B, the ticket award 930 is applied, and in this example is applied to the first hand 934A, where a flush of spades has been forced. The forced win methodologies described herein may be used to cause hand 934A (and/or any other hands 934B, 934C) to exhibit the card characteristics mandated by the guaranteed win pull tab 930. In one embodiment, the guaranteed win or other award identified by the ticket award 930 is not applied to the first hand 934A, but to one or more of the additional hands 934B, 934C being played. In yet another embodiment, the guaranteed win or other award identified by the ticket award 930 is applied to all hands 934A, 934B, 934C.

In this example, a payout will be provided for the forced win on hand 934A. As this example is a multi-play example, cards may be held in the first hand 934A which are replicated into the other hands 934B, 934C. The player could have held all five cards 941, 942, 943, 944, 945 of hand 934A into each of the other two hands 934B, 934C, and ensured wins on each of those other hands 934B, 934C. Alternatively, as in the illustrated embodiment of FIG. 9B, the player has opted to hold cards 941, 943 and 944, thereby replicating them into hands 934B, 934C, hoping that draw cards 952, 955, 962 and 965 will provide a higher payout than the flush, namely, a straight or royal flush. In the illustrated example, hand 934B did not result in any winning poker hand (and no payout), but hand 934C resulted in a royal flush.

The pull tab 930 may be used in such poker embodiments, and a physical or virtual bin of such pull tabs may be provided. Pull tab (or other ticket) awards may include forced results as described in connection with FIGS. 9A/9B, or as described elsewhere herein, may instead or additionally provide payout modifiers, enriched poker decks (e.g., adding Aces to the deck, or wild cards to the deck, etc.), etc.

The foregoing description of the representative embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out above.

What is claimed is:

1. A slot game apparatus for providing gaming awards in a slot game, comprising:
a display presenting a plurality of symbols in symbol locations forming a symbol array;
a user interface including at least one user input to enable a player to initiate and participate in a slot game event presented via the symbol array;
a wager input device structured to identify and validate player assets, and to permit the player to play the slot game events when the player assets are provided; and
a processor configured to:
populate the symbol array with the plurality of symbols for player participation in the slot game event;
maintain a listing of available gaming ticket awards and their respective quantities available for awarding, and direct the display to present the listing;
select one of the available gaming ticket awards that has a non-zero quantity available for awarding;
award the selected gaming ticket award;
update the quantity of the available gaming award tickets for the selected gaming ticket award to reduce its respective quantity available for awarding as a result of awarding the selected gaming ticket award; and
provide a slot event outcome of the slot game in addition to awarding the selected gaming ticket award.

2. The slot game apparatus of claim 1, wherein the selected gaming ticket award comprises a guaranteed symbol combination, and wherein the processor is configured to force the symbol array to be populated with at least the guaranteed symbol combination.

3. The slot game apparatus of claim 1, wherein the selected gaming ticket award comprises a payout modifier, and wherein the processor is configured to increase a payout from the slot event outcome based on the payout modifier.

4. The slot game apparatus of claim 1, wherein the selected gaming ticket award comprises one or more predetermined symbols of value, and wherein the processor is configured to populate the symbol array with the plurality of symbols and with the one or more predetermined symbols of value.

5. The slot game apparatus of claim 1, wherein the processor is configured to reset the quantities of available gaming ticket awards to a reset state, in response to a predetermined quantity of the gaming ticket awards being awarded.

6. The slot game apparatus of claim 5, wherein the predetermined quantity of the gaming ticket awards comprises all of the gaming ticket awards.

7. The slot game apparatus of claim 1, wherein the processor is configured to select one of the available gaming ticket awards by randomly selecting among the available gaming ticket awards based on a relative selection weighting.

8. The slot game apparatus of claim 1, wherein the processor is configured to select one of the available gaming ticket awards on a random basis.

9. The slot game apparatus of claim 1, wherein the processor is configured to select one of the available gaming ticket awards in connection with each of the slot game events.

10. The slot game apparatus of claim 1, wherein the display further presents a representation of a pull tab bin, and wherein the processor is configured to select one of the available gaming ticket awards by removing the selected one of the available gaming ticket awards from the pull tab bin.

11. The slot game apparatus of claim 1, wherein the processor is configured to award the selected gaming ticket award for use with a current slot game event.

12. The slot game apparatus of claim 1, wherein the processor is configured to award the selected gaming ticket award for use with a future slot game event.

13. A gaming apparatus utilizing symbols to identify winning results, comprising:
a symbol selection module configured to select symbols for a slot game event;
a display to present the selected symbols in a symbol array of the slot game event, and to present a listing of available pull tab awards and their respective quantities available to be awarded;
a pull tab selection module configured to select one of the pull tab awards available to be awarded;
an award availability maintenance module coupled to the pull tab selection module to receive an identification of the selected one of the pull tab awards, and to update the listing of available pull tab awards by decrementing the quantity of the selected pull tab award as a result of it being selected; and
an award enhancement module configured to apply the selected pull tab award to arrive at a total payout for the slot game event.

14. The gaming apparatus of claim 13, wherein the selected pull tab award comprises a slot game event outcome, and further comprising a forced outcome module coupled to the symbol selection module to force the slot game event outcome onto a symbol grid of the slot game event.

15. The gaming apparatus of claim 14, wherein the award enhancement module is configured to apply the slot game event outcome to the symbol selection module by way of the forced outcome module, to arrive at a total payout for the slot game event, including a payout for the slot game event outcome forced onto the symbol grid of the slot game event.

16. The gaming apparatus of claim 14, wherein the slot game event outcome comprises a predetermined symbol combination, a progressive jackpot, or a bonus event trigger.

17. The gaming apparatus of claim 13, wherein the selected pull tab award comprises a payout modifier, and wherein the award enhancement module is configured to apply the payout modifier to a payout of the slot game event to arrive at the total payout for the slot game event.

18. The gaming apparatus of claim 13, wherein the selected pull tab award comprises enriched symbol characteristics, and wherein the award enhancement module is coupled to the symbol selection module to cause the symbol selection module to apply the enriched symbol characteristics to the symbols selected for the slot game event.

19. The gaming apparatus of claim 13, further comprising a pull tab offering determination module configured to randomly select the slot game events in which the pull tab selection module is to select one of the pull tab awards.

20. A method for providing gaming awards in a slot game, comprising:
populating the symbol array with a plurality of slot game symbols for player participation in a slot game event;
maintaining a listing of available gaming ticket awards and their respective quantities available for awarding
directing the display to present the listing;
selecting one of the available gaming ticket awards that has a non-zero quantity available for awarding, and that identifies a symbol combination to apply to the next slot game event;
awarding the selected gaming ticket award;
updating the quantity of the available gaming award tickets for the selected gaming ticket award to reduce its respective quantity available for awarding as a result of awarding the selected gaming ticket award;
providing a slot event outcome of the slot game in addition to awarding the selected gaming ticket award; and
forcing the next slot game event to be populated with at least the identified symbol combination.
